(19) United States
(12) Patent Application Publication
(10) Pub. No.: US 2005/0117073 A1
(43) Pub. Date: Jun. 2, 2005

(54) Interactive video system

(76) Inventors: Roger A. Payne, Ipswich (GB); Christopher S. Ormston, Ipswich (GB); Andrew J. Hardwick, Ipswich (GB); Peter J. Brown, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/508,030

(22) PCT Filed: Mar. 11, 2003
(86) PCT No.: PCT/GB03/00997

(30) Foreign Application Priority Data
Mar. 22, 2002 (EP) 02252059.7

(51) Int. Cl. H04N 5/64

(52) U.S. Cl. 348/744

(57) ABSTRACT

Apparatus for an interactive video system comprising a transmissive projection screen (8) from which an image projected on to the rear surface is visible from the front side but not visible from the rear side, a projector (20) to project display images on to the rear surface of the screen (8); and a video camera (22) positioned to video a user (2) in front of the screen (8). The user (2) effects a writing action on the screen (8) using a dry pen (24) comprising infrared LEDs (64) which operate when the dry pen (24) is pressed against the screen (8). These emissions are detected and position decoded, and a corresponding image projected on the screen (8) so it appears as direct writing to the user (2). The videoed image of the user and the input written data may be combined and transmitted during a videoconference to corresponding apparatus used by a further user (4) who thereby sees interaction between the first user (2) and the written data.

The present invention relates to interactive video systems, which may be used, for example, in videoconferencing applications. The present invention also relates to apparatus for such interactive video systems. The present invention also relates to “digital whiteboards” and “dry pens”.

Videoconferencing systems are known in which a participant is filmed by a video camera and the resulting video image signals are transmitted to one or more other participants in a videoconference, along with audio signals. The signals may be transmitted over one-to-one telecommunication links, e.g. over a public switched telephone network (PSTN) or via direct video link using e.g. co-axial cable, or for example may be transmitted via the Internet.

The participant(s) receiving the video signal may display the video image corresponding to the video signal in any convenient manner, e.g. using a video player and television monitor, or using suitable software applications to display the video image on a screen of a personal computer (PC). In the latter case, it is also known to transmit, receive and display other visual information during the videoconference using other PC software applications. Such other visual information may be pre-prepared diagrams, charts, etc.

A limitation of the above described known systems is that the video image of the participant is separate from the other visual information, for example it is displayed in a separate window on the PC screen. Moreover, any interaction between the participant and the other visual information, e.g. pointing to a particular feature on a diagram or chart forming the other visual information, is not conveyed to the other participants, as the received image of the participant, even if it includes the pointing gesture as such, is not visually linked to the other visual information.

A further limitation with the other visual information is that it is not possible for the first participant to alter or add to this conveniently, i.e. by free hand drawing or writing. This would however often be done in a face-to-face meeting, in which the other visual information might well be presented on a flip-chart or whiteboard. Digital whiteboards are known which allow hand drawn images to be captured digitally. One known way is for a drawn image to be scanned by passing the whiteboard surface through a scanner. Another known way is for ultrasonic sensors to be located at edges of the electronic whiteboard, and the pen to be a so-called “dry pen”, which does not actually draw lines with ink but instead otherwise sends a signal, in this case an ultrasonic signal when pressed against the whiteboard, which signal is decoded by the sensors and the corresponding image displayed electronically on the whiteboard. However, the present inventors have realised that even were the use of such a digital whiteboard to be contemplated as part of a videoconferencing system, this would still suffer the above described limitation of the other visual information thereby provided being separate from the video image of the participant.

Completely separate from both the different fields of videoconferencing and digital whiteboards, a projection technology is known in which a glass screen is coated with a plastic holographic, refracting or diffracting layer or film. When an image is projected on to the rear surface of the screen at a predetermined angle to the screen, for example at 36.4° (to the normal), the image is visible from the front side of the screen but not from the rear side of the screen. One such screen and projection system is produced by Hitachi and known as “Holo AirSho System”™. Another system is known as “HoloPro” ™. Such projection technology is used for example in shop windows so that passers by outside the shop may see an image containing advertising content but customers inside the shop may still see clearly out of the shop window. Such screens will hereinafter be referred to as transmissive projection screens. They are also known as rear projection screens.

In a first aspect the present invention provides interactive video apparatus, comprising a transmissive projection screen, wherein the transmissive projection screen comprises a front surface located on a front side and a rear surface located on an opposing rear side and is such that an image projected on to the rear surface is visible from the front side but substantially not visible from the rear side; a projector arranged to project images on to the rear surface of the transmissive projection screen; and a video camera positioned to video, through the transmissive projection screen, a first user positioned to the front side of the transmissive projection screen whilst the images are projected on to the rear surface of the transmissive projection screen.

Preferably the apparatus is arranged to mix image information received from the user being videoed with a reversed, in a mirror image sense, version of the video image of the user being videoed, and to transmit such mixed image data to a further user for display.

Preferably a video mixer mixes the different video signals, to provide a composite video image, in which the image information and reversed video image(s) are combined with positional correspondence, thereby substantially showing the interaction of the user with the image information.

Preferably the further user uses corresponding apparatus to display the mixed or composite image during a videoconference.

The image information received from, i.e. input by, the user may comprise PC processed information. Additionally or alternatively, the image information input by the user may be derived from pseudo-writing performed by the user on the surface of the transmissive projection screen using a dry pen/electronic whiteboard arrangement. Preferably the dry pen comprises infrared LEDs activated when a dummy nib of the dry pin is pressed against and moved along the front surface of the transmissive projection screen. An infrared detector or camera positioned behind the screen detects the emissions from the infrared LEDs. Position references are included on the transmissive projection screen, and from these the position of the dry pen when emitting the infrared is determined. The corresponding image, e.g. drawings and/or text etc. produced in handwritten form by the user is projected from the projector to the screen, such that it appears to the user that he is actually drawing or writing on the front surface of the screen.

Preferably the dry pen comprises a plurality of infrared LEDs arranged on the dry pen such that they are visible to the infrared detector from different positions and/or angles, for example formed in an annular ring around a dummy nib. The dummy nib, when pressed against the screen, activates a switch that switches the infrared LEDs on.

The infrared pen may operate the infrared LEDs at different frequencies (or other coding technique) to provide colour choices. The pen may contain a selector switch for choosing such colour choice. The selected frequency is detected by the infrared detector, and the corresponding image lines are projected in the appropriate colour. Alternatively, each pen may operate at only one frequency, but a set of pens is provided each with a different frequency (or other coding) to provide a respective different colour.

In a further aspect the present invention provides an interactive video system, for example a videoconferencing system, comprising respective apparatus according to the first aspect above (including any preferred versions thereof) for each user participating, the respective apparatuses being remotely connected to each other over a suitable communication link, for example over a PSTN or over the Internet.

In a further aspect the present invention provides a dry pen and electronic whiteboard arrangement comprising a dry pen providing an output when pressed against the front of a transmissive projection screen by a user performing pseudo-writing and detection means for detecting the output and determining the x, y coordinates of the dry pen on the screen when the output is produced, arranged with a projector for projecting the resulting image on to the rear of screen, to be visible from the front the screen to the user performing the pseudo-writing.

Preferably, the dry pen output is provided by one or more infrared LEDs activated when a dummy nib of the dry pin is pressed against and moved along the front surface of the transmissive projection screen. An infrared detector or camera positioned behind the screen detects the emissions from the infrared LEDs. Position references are included on the transmissive projection screen, and from these the position of the dry pen when emitting the infrared is determined. The corresponding image, e.g. drawings and/or text etc. produced in handwritten form by the user is projected from the projector to the screen, such that it appears to the user that he is actually drawing or writing on the front surface of the screen.

Preferably the dry pen comprises a plurality of infrared LEDs arranged on the dry pen such that they are visible to the infrared detector from different positions and/or angles, for example formed in an annular ring around a dummy nib. The dummy nib, when pressed against the screen, activates a switch that switches the infrared LEDs on.

The infrared pen may operate the infrared LEDs at different frequencies (or other coding technique) to provide colour choices. The pen may contain a selector switch for choosing such colour choice. The selected frequency is detected by the infrared detector, and the corresponding image lines are projected in the appropriate colour. Alternatively, each pen may operate at only one frequency, a set of pens being provided each with a different frequency (or other coding) to provide a respective different colour.

In a further aspect the present invention provides a dry pen as described above with respect to any of the previous aspects.

In a further aspect the present invention provides apparatus for an interactive video system comprising a transmissive projection screen from which an image projected on to the rear surface is visible from the front side but not visible from the rear side; a projector to project display images on to the rear surface of the transmissive projection screen; and a video camera positioned to video a user in front of the transmissive projection screen. The user effects a writing action on the screen using a dry pen comprising, for example, infrared LEDs which operate when the dry pen is pressed against the screen. These emissions are detected and position decoded, and a corresponding image projected on the screen so it appears as direct writing to the user. The videoed image of the user and the input written data may be combined and transmitted to corresponding apparatus used by a further user who thereby sees interaction between the first user and the written data, for example in a videoconference.

Further aspects are as claimed in the appended claims.

Embodiments of the invention will now be described, by way of example only, with reference to the accompanying drawings, in which:

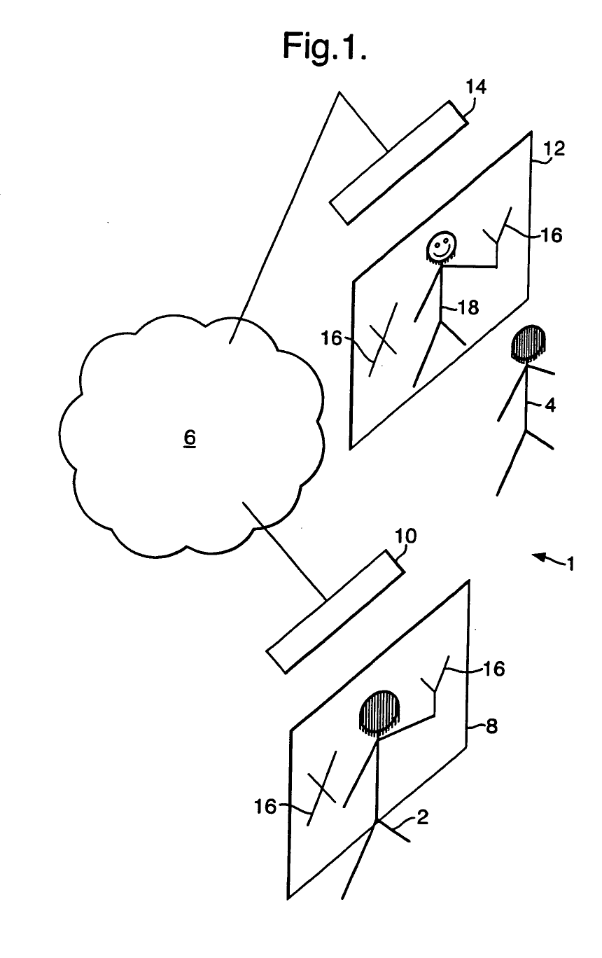

FIG. 1 shows an overview of an interactive video system;

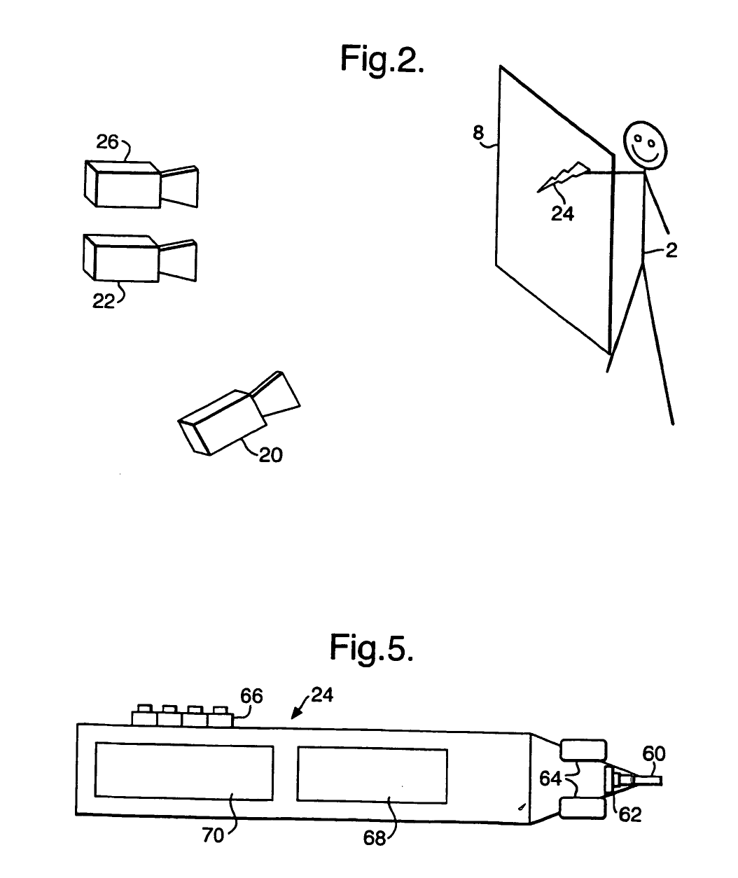

FIG. 2 shows certain elements of the interactive video system of FIG. 1;

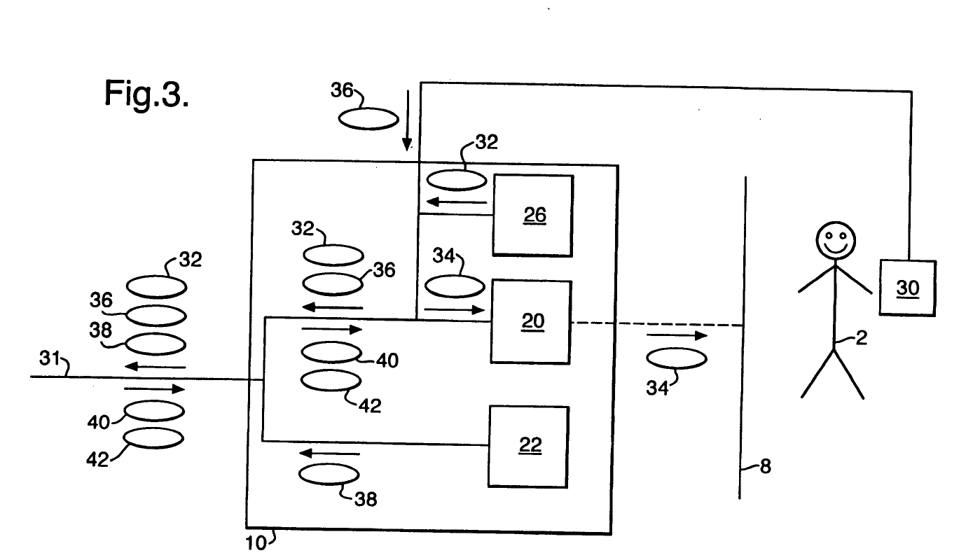

FIG. 3 is a block diagram showing certain elements of the interactive video system of FIG. 1 and ways in which various signals and data are distributed between these elements;

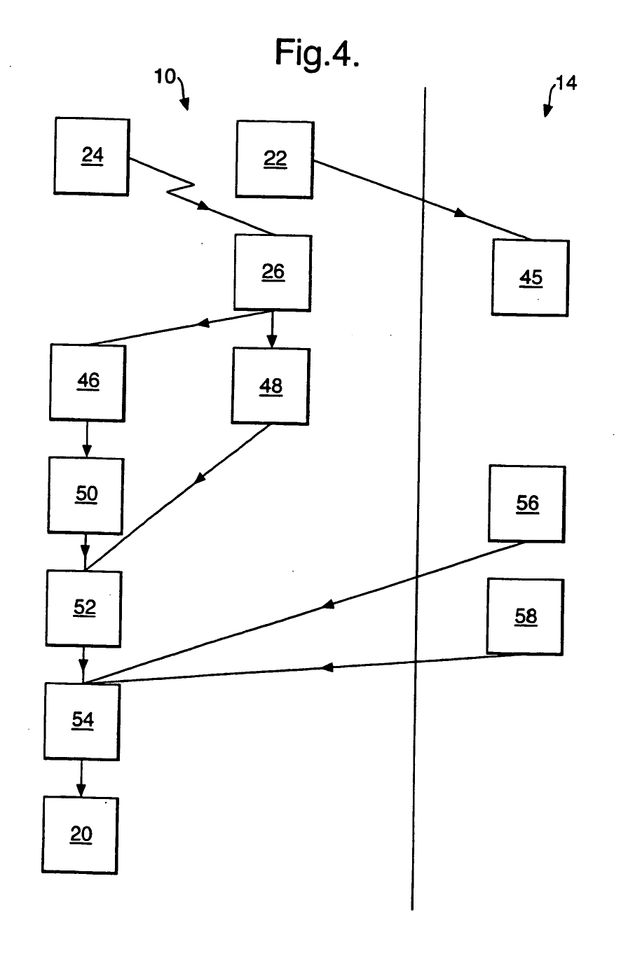

FIG. 4 shows certain modules and elements of a first control apparatus and a second control apparatus of the interactive video system of FIG. 1, and their interconnections; and

FIG. 5 is a schematic illustration of a dry pen.

FIG. 1 shows an overview of an interactive video system 1 incorporating a first embodiment of the invention. The interactive video system 1 allows a first user 2 to conduct a videoconference with a second user 4 over any suitable communication link or network, in this case the Internet 6. The interactive video system 1 comprises, for use by the first user 2, a first transmissive projection screen, hereinafter referred to as a first screen, and first control apparatus 10. The interactive video system 1 further comprises, for use by the second user 4, a second transmissive projection screen, hereinafter referred to as a second screen 12, and second control apparatus 14.

By way of a simple example, a situation is shown where visual information 16 has been provided in electronic form to the first control apparatus 10. This visual information 16 may be so provided in a number of different ways that will be described more fully below. The image of the visual information 16 is projected from the first control apparatus 10 on to the rear surface of the first screen 8 and is thereby displayed on the front surface of the first screen 8 to the first user 2 as shown. In this example the visual information 16 comprises the letters “X” and “Y” as shown.

FIG. 1 shows a point in the videoconference when the first user 2 is speaking and interacting with the visual information 16 by, for example, pointing to or touching the bottom of the letter Y.

The first control apparatus 10 comprises a video camera that videos the action of the first user 2 (the first screen 8 being substantially transparent when viewed from the rear, and the visual information 16 not being seen from the rear). The first control apparatus 10 transmits the resulting video signal, and the electronic form of the visual information 16, via the Internet to the second control apparatus 14.

The second control apparatus 14 projects the visual information 16 and the video image of the first user 2 on to the rear surface of the second screen 12, so that they are both visible to the second user 4 positioned to the front of the second screen 12. This enables the second user 4 to see a combined image of the visual information 16 and the first user 2, and more particularly the interaction of the first user 2 with the visual information 16. A further detail is that the video image of the first user as displayed is actually made to be a reversed image 18 of the first user, in a mirror image sense. Thus, whereas the first user 2 pointed to the letter Y with his right hand, the reversed image 18 shows him apparently using his left hand. This reversal is used to adjust for the fact that the first user 2 has been videoed from a face on perspective but his image is projected from behind. This reversal of the video signal or image may be performed by either the first control apparatus 10 or the second control apparatus 14.

The second control apparatus 14 comprises a video camera for videoing the second user 4, and the corresponding video image is transmitted to the first control apparatus 10 for reversed display on the first screen 8, in combination with the visual information 16, at appropriate stages of the videoconference.

This embodiment will now be described in further detail by describing the elements of the first control apparatus 10 and first screen 8, but the following description applies in corresponding fashion to the second control apparatus 14 and second screen 12.

FIG. 2 shows certain elements of the interactive video system 1 as used by the first user 2, namely the first screen 8, a dry pen 24, and the following items located to the rear of the first screen: a projector 20, a video camera 22, and an infrared detector 26.

The first screen 8 is a transmissive projection screen, i.e. a glass (or other appropriate transparent medium) screen coated with a plastic holographic, refracting or diffracting layer or film comprising holographic-optical elements. When an image is projected on to the rear surface of the screen 8 at a predetermined angle to the screen, here 36.4° to the normal, the image is visible from the front side of the screen but not from the rear side of the screen 8. One such screen and projection system is known as “HoloPro”™, and is available from G+B pronova GmbH, Lustheide 85, D-51427 Bergisch Gladbach, Germany. Another such screen and projection system is produced by Hitachi and known as “Holo AirSho System”. Any other screen technology providing the same form of operation may also be used.

The projector 20 is arranged to project images on to the rear surface of the first screen 8 at the angle of operation of the first screen 8, i.e. in this example at 35°. The projector 20 is a high brightness projector, with heavy keystone correction to give a good level of compensation for the angular projection of the image on to the first screen 8. In operation the projector 20 serves to project the visual information 16 and/or a reversed video image of the second user 4 on to the rear of the first screen 8 for viewing from the front side by the first user 2.

The video camera 22 is arranged to video the first user 2, the first user 2 being seen by the video camera 22 through the first screen 8. This is possible due to the first screen 8 being substantially transparent. Moreover, the visual information 16 is not seen by the video camera 22, due to the characteristic of the first screen 8 by which images projected on to the rear surface are visible from the front but not from the rear.

In this embodiment there are two basic ways in which the visual information 16 is provided. One of these is by the first screen 8 being used as a digital whiteboard, involving use of the dry pen 24 and infrared detector 26 shown in FIG. 2, as follows. The dry pen 24 comprises a plurality of infrared light emitting diodes (LEDs) that are activated when the dry pen 24 is pressed against the first screen 8, i.e. during “writing”. (Further details of the dry pen will be described later below.) The infrared detector 26 detects the infrared signals emitted by the dry pen 24. The infrared detector 26, which may be an infrared camera, along with processing electronics not shown, is set to the size of the first screen 8, and arranged to determine the x, y coordinate position of the pen with respect to the sides of the first screen 8 in any appropriate manner. In this example this is achieved by infrared reflectors being positioned at each corner of the first screen 8 to provide reference points, and the system is previously calibrated using these reference points. The positions determined for the dry pen in operation are processed to provide the resulting image of the visual information 16, e.g. the letters X and Y as shown in FIG. 1, using conventional software and processing techniques, as with a conventional PC mouse input. Thus the impression is given to first user 2 that the dry pen 24 is writing directly on the front of the first screen 8. The second screen 12 also operates as a digital whiteboard in the same fashion, and inputs may thereby be provided using a dry pen by the second user 4.

FIG. 3 is a block diagram showing certain elements of the interactive video system 1 as used by the first user 2, along with showing the ways in which various signals and data are distributed between these elements. The following items previously described above are shown in FIG. 3: the first user 2, the first screen 8, and the first control apparatus 10 comprising the projector 20, the video camera 22 and the infrared detector 26. Also included is a PC 30 used by the first user 2 to implement the second basic way in which the visual information 16 is provided.

Any suitable control and processing electronics, including optionally one or more PCs and appropriate software, may be included in and used by the first control apparatus 10 to implement control and operation of projector 20, the video camera 22 and the infrared detector 26, including routing of data and images as described below. Also shown in FIG. 3 is an input/output 31 of the first control apparatus 10 from which data and signals are transmitted to and received from the second control apparatus 14 via the Internet 6.

The PC 30 is used by the first user 2 to provide data defining some or all of the visual information 16, and this is forwarded to the first control apparatus over a conventional PC interface. The data may be created by the first user 2 typing or otherwise producing input in real-time during the videoconference, or by selectively outputting predetermined saved material such as charts or diagrams prepared using software such as Powerpoint™ available from Microsoft™. This data is hereinafter referred to as the PC component 32 of the visual information.

In this example the first user is also able to “draw” over the PC component 36 of the visual information using the dry pen 24 as detected by the infrared detector 26. This produces as an output from the infrared detector 26 a further component of the visual information 16, which is hereinafter referred to as the pen component 32 of the visual information.

As described earlier, the video camera 22 videos the first user 2 to provide a video image of the first user, indicated in FIG. 3 by reference numeral 38.

In this embodiment the first control apparatus receives, at the input/output 31, from the second user 4, a remote component 40 of the visual information 16. This may, for example, be “writing” added by the second user 4 using a dry pen/infrared detector arrangement at the second screen 12, and/or input provided by the second user 4 using a PC. The first control apparatus also receives, at the input/output 31, a video image 42 of the second user 4 provided by a video camera in the second control apparatus 14. This video image 42 of the second user 4 is either received in a reversed form, or is reversed (in a mirror image sense) by the first control apparatus 10.

The pen component 32 of the visual information, the PC component 36 of the visual information, and the video image 38 of the first user are forwarded to the input/output 31 from where they are transmitted to the second control apparatus 14 via the Internet 6. (The video image 38 of the first user is either reversed by the first control apparatus 10 before being transmitted or is transmitted as recorded and then reversed by the second control apparatus 14.)

Additionally, the pen component 32 of the visual information, the PC component 36 of the visual information, the remote component 40 of the visual information and the video image 42 of the second user are combined by the first control apparatus 10 to form a composite image 34 of these four components which is forwarded to the projector 20 which projects the composite image 34 on to the rear of the first screen 8 such that it is visible from the front side to the first user 2.

In this embodiment the dry pen 24 comprises an optional feature by which colour images may be detected and displayed. The infrared LEDs are driven at different frequencies to represent different colours, e.g. red, blue, green etc. The different colours are selected by the user. Alternatively, there may be different dry pens for different colours, each pre-arranged to drive its infrared LEDs at a different frequency. The resulting image can then be projected in these colours to replicate the intentions of the user drawing or writing the information.

FIG. 4 shows certain modules and elements of the first control apparatus 10 and the second control apparatus 14 and their interconnections. In this embodiment, the second control apparatus 14 comprises elements and modules corresponding to all of the elements and modules shown for the first control apparatus 10, but for clarity only some of these are shown. The following will describe certain aspects of the way the first control apparatus 10 processes the different possible colours. The following will also provide some further details of how the different images are prepared and mixed before being projected by the projector 20. For clarity a situation will be considered where the visual information 16 only comprises inputs provided using the dry pens, i.e. there is no visual information input by the users using PCs.

Referring to FIG. 4, the output from the video camera 22 of the first control apparatus 10 is transmitted to the second control apparatus 14 (as described earlier) where it is forwarded to a video mixer 45 of the second control apparatus. The infrared signals from the dry pen 24 are received by the infrared detector 26.

They are then passed to a frequency detector 46 and a pen position decoder 48. The frequency detector 46 determines the frequency of the received signals, and passes this result to a frequency-to-colour look-up table 50. The identity of the colour determined by the frequency-to-colour look-up table 50 is passed to a PC 52 (this PC forming part of the control apparatus 10 is not to be confused with the earlier described PC 30 accessed directly by the first user 2). The pen position decoder 48 determines the positions the signals were received from, and passes this information to the PC 52.

The PC 52 analyses the data received and provides a video signal corresponding to the coloured image to be displayed according to the processing results derived from the received dry pen signals. This video signal is passed to a video mixer 54 of the first control apparatus 10.

The video mixer 54 of the first control apparatus 10 also receives a video signal from a PC of the second control apparatus 14 comprising a video signal of any dry pen input provided remotely by the second user 4. Furthermore, the video mixer 54 also receives a video signal from a video camera 58 of the second control apparatus 14 comprising a video of the second user 4.

In other embodiments the received video of the second user 4 may already have been reversed by the second control apparatus before being transmitted to the first control apparatus 10, however in this embodiment a non-reversed version is received, and the video image is reversed by the video mixer 54 of the first control apparatus 10.

The video mixer 54 of the first control apparatus 10 then mixes all the different video signals, to provide a composite video image, in which the visual information 16 and the reversed image of the second user 4 is combined with positional correspondence substantially showing the interaction of the second user 4 with the visual information 16. The video mixer may be implemented in any suitable manner. In this embodiment the video mixer is effectively a further PC. Another possibility is for a standard video mixing desk to be adapted for automatic use, in which case the video inputs to it should preferably themselves first be converted to composite video.

The final composite video image is then forwarded to the projector 20 for projection on to the rear of the first screen 8.

In this embodiment the video mixer 54 is controllable such that the first user 2 may select at any stage during the videoconference which single one or which combination of the following is displayed on the first screen 8: the video image of the second user 4, and the separate constituents of the visual information, i.e. any pen component of the visual information as provided by the other user, any pen component of the visual information as provided by the first user 2 himself, any PC component of the visual information provided by the other user, any PC component of the visual information provided by the first user 2 himself. For example, FIG. 1 may be considered to be showing a situation where the second user 4 has selected to see all available information (or has no means for selecting only certain parts) whereas the first user 2 has selected at this stage to only see the visual information 16 rather than the video image of the second user 4, perhaps because the first user 2 is writing some detailed information on the first screen 8 with the dry pen 24 and does not wish to be distracted. In this embodiment the first user 2 controls this selection using a conventional infrared remote control handset which is detected by detection and processing elements (not shown) in the first control apparatus 10, although any conventional control or user input approach could be employed. Another possibility is for such selection of what is to be displayed to be controlled by some automatic process run by the first control apparatus, detecting for example which user is speaking or writing or inputting PC data at any particular moment and displaying different items accordingly by implementing pre-programmed algorithms. Another possibility is that the video image of the other user is reduced in size at some stages, automatically or under influence of user input, so that the visual information is more clearly visible but the other user can still be seen, albeit with a reduction in the effectiveness with which the other user's direct interaction with the visual information can be seen or is positionally accurate.

In many applications or situations the visual information 16 will be sufficiently visible even though combined with a user's video image, irrespective of the background the user being videoed is standing in front of. However, this can be improved in various ways if desired. For example, in this embodiment the first user 2 and second user 4 stand in front of white backgrounds during the video conference to improve their visibility in the resulting video images of them and to reduce any clashes with the visual information 16 also being displayed. Another possibility is for video cut-out techniques to be used, e.g. the user stands in front of a blue background and standard video cut-out techniques are applied to the video image such that only the user himself is shown in the resulting video image.

The voices of the users are picked-up and the resulting audio signals transmitted between the two control apparatus in any conventional manner. The audio signals may be kept separate from the above described video signals or mixed therewith as required.

Further details of the dry pen 24 will now be described. FIG. 5 is a schematic illustration of the dry pen 24. The dry pen comprises a nib 60, a nib switch 62, a plurality of infrared LEDs 64 arranged in an annulus around the nib 60, a colour selector switch 66, a frequency generator 68, and a battery 70. The nib 60 is of a suitable material to provide the user with the usual writing feel, whilst not damaging the screen. In this embodiment the nib 60 is made of felt. When the nib 60 is pressed against the screen, the nib switch 62 is activated and the infrared LEDs 64 are driven. As mentioned above, in this embodiment the dry pen provides different colours by means of different frequencies being applied to the infrared LEDS and decoded appropriately by the first control apparatus 10. The desired colour for writing is selected by the user using the colour selector switch 66, which determines the frequency the infrared LEDs 64 are driven at by the frequency generator 68. The dry pen 24 is powered by the battery 70.

In the above embodiment, the interactive video system comprises respective screens and control apparatus for both users. However, it will be appreciated that in another possible arrangement, the first user 2 is equipped with the first screen 8 and the first control apparatus 10 as above, but the other user is merely equipped with conventional videoconferencing apparatus, e.g. a PC showing the visual information separate from the video image of the first user 2.

In the above embodiments, the first control apparatus 10 in conjunction with the first screen 8, i.e. apparatus directly used by the first user 1, is able to both provide both an interactive output for the second (i.e. other) user 4 and an interactive input for the first user 2 himself. The interactive output for the second (i.e. other) user 4 comprises, in summary, some or all the visual information 16 combined with the video image of the first user 2 as he interacts with the visual information. The interactive input for the first user 2 himself comprises, in summary, some or all of the visual information 16 plus the received video image of the second user 4. In other embodiments, however, the first control apparatus 10 in conjunction with the first screen 8 is only able to provide the interactive output for the second (i.e. other) user 4, e.g. in a simpler version of the apparatus, the first control apparatus may comprise the projector and video camera, plus some means for visual information provided by the first user 2 to be projected by the projector, but need not comprise means for receiving and mixing in visual information and/or the second user's video image from the second user's end of the system.

In other embodiments, more than two users may be provided with any of the above described apparatus, i.e. the number of users participating in a videoconference using the above described system is not limited to two.

In the above embodiment, the data is transmitted between the users' apparatus vie the Internet, but in other embodiments any appropriate communications link and/or network may be employed, for example a PSTN or an intranet.

Although the above embodiment has been described in the context of a videoconference with the composite video images comprising the visual information plus the video image of a user being used immediately in real-time, it will be appreciated that the resulting composite video images may be recorded and viewed at a later time (and possibly edited in the meantime). Thus, for example, training videos could be recorded by a user. Another possibility is that the composite video may be transmitted in real-time, but to a viewer or viewers who only participate passively, i.e. do not use any means for responding to the information.

Another possibility is that the video image of the first user may be included in the video image displayed on the first screen by the first control apparatus, for example when so requested by the first user using the earlier described infrared remote control. This may be done for example shortly prior to the start of the videoconference, or intermittently during it, to enable the first user to review the video image of himself.

In the above embodiments the dry pen provides replication of colour images by virtue of the different frequencies selectable for driving the infrared LEDs. However, rather than different frequencies, any other suitable modulation technique may be used to provide recognisably different signals, e.g. simple digital encoding.

In other simpler embodiments, the dry pen does not offer different colours, and no selectable frequency capability need be included.

In the above embodiment the dry pen comprises a plurality of infrared LEDs that are arranged as an annulus around the nib of the pen. This advantageously allows at least one or more of the infrared LEDs to be seen by the infrared detector irrespective of the viewing angle caused by the position of the pen on the screen and/or the angle at which the nib of the pen is pressed against the screen by the user. However, in other embodiments, the infrared LEDs may be arranged in other ways, or the dry pen may comprise only one infrared LED.

In other embodiments, the video camera and all aspects related to the videoing of the users may be omitted. In these embodiments a digital whiteboard system is thereby provided, the digital whiteboard system comprising a dry pen, a dry pen output detector, a transmissive projection screen, a projector, and control apparatus for these items, each as included in any of the embodiments described above. Digital whiteboard systems according to these embodiments are capable of use in may situations other than videoconferencing. For example, they may be used for conventional face-to-face meetings, lectures, and so on.

Also, in other embodiments, instead of the dry pen comprising infrared LEDs, other dry pen/digital whiteboard techniques may be employed for capturing “writing” being applied to the screen by the user using a dry pen. For example, ultrasonic sensors may be located at edges of the screen, the dry pen being one that sends an ultrasonic signal when pressed against the screen.

Furthermore, in other embodiments there is no provision for the visual information to include hand drawn input from a dry pen, and instead only the visual information provided by the user via a PC or similar means is catered for. In this case the dry pen and dry pen detection means may of course be omitted.

In other embodiments the various components of the visual information and the users' video images may be mixed at any different stages in their routing through and between the various elements of the various apparatuses, i.e. such mixing need not take place at the stages specifically described in the above embodiments.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. Apparatus for an interactive video system, comprising: a transmissive projection screen, wherein the transmissive projection screen comprises a front surface located on a front side and a rear surface located on an opposing rear side and is such that an image projected on to the rear surface at a predetermined angle is visible from the front side but substantially not visible from the rear side; a projector positioned to the rear side of the transmissive projection screen to project display images on to the rear surface of the transmissive projection screen at the predetermined angle; and a video camera positioned to video, through the transmissive projection screen, a first user positioned to the front side of the transmissive projection screen.

2. Apparatus according to claim 1, further comprising means for mixing at least a component part of the display images and a video image of the first user provided by the videoing of the first user.

3. Apparatus according to claim 1, further comprising means for the first user to input visual information to the apparatus, and wherein the display images comprise the input visual information.

4. Apparatus according to claim 1, further comprising means for transmitting the display images and the video image of the first user to a remote apparatus.

5. Apparatus according to claim 1, further comprising means for reversing the video image of the first user.

6. Apparatus according to claim 1, further comprising means for receiving and projecting visual information from a second user taking part in a videoconference with the first user, the display images comprising the visual information received from the second user.

7. Apparatus according to claim 1, further comprising means for receiving and projecting a video image of a second user taking part in a videoconference with the first user, the display images comprising the received video image of the second user.

8. Apparatus according to claim 1, further comprising means for receiving, reversing and projecting a video image of a second user taking part in a videoconference with the first user, the display images comprising the reversed version of the received video image of the second user.

9. Apparatus according to claim 3, further comprising means for selecting, to be projected on to the transmissive projection screen, any one or any combination of the following: (i) the reversed video image of the second user; (ii) a reversed video image of the first user; (iii) that part of the visual information input by the second user; (iv) that part of the visual information input by the first user.

10. Apparatus according to claim 3, further comprising a dry pen system, the dry pen system comprising a dry pen and a dry pen detection means for detecting where on the front surface of the transmissive projection screen the dry pen is being pressed to effect a writing action; and wherein at least some of the visual information input by the first user is provided by the user effecting a writing action by pressing and moving the dry pen on the front surface of the transmissive projection screen.

11. Apparatus according to claim 10, wherein the dry pen comprises one or more infrared LEDs arranged to emit infrared signals when the dry pen is pressed against a surface; and the dry pen system comprises an infrared detector positioned to the rear side of the transmissive projection screen for detecting the infrared signals.

12. Apparatus according to claim 11, wherein the dry pen comprises plural infrared LEDs arranged in an annular ring around a nib of the dry pen.

13. Apparatus according to claim 11, wherein the dry pen comprises a colour selector switch and wherein the emitted infrared signals are modulated or coded according to a colour selected using the colour selector switch; and the dry pen system further comprises means for demodulating or decoding the infrared signals to determine which colour was selected and dependent thereon projecting the written image in the selected colour.

14. Apparatus according to claim 13, wherein the emitted infrared signals are modulated by driving the infrared LEDs at different frequencies.

15. A videoconferencing system, comprising two or more apparatus for remote connection with each other, one or more of the apparatus being according to claim 1.

16. A digital whiteboard system, comprising: a dry pen arranged to emit output signals when pressed against a surface; a transmissive projection screen, wherein the transmissive projection screen comprises a front surface located on a front side and a rear surface located on an opposing rear side and is such that an image projected on to the rear surface at a predetermined angle is visible from the front side but substantially not visible from the rear side; a detector for detecting output signals emitted when the dry pen is pressed against the front surface of the transmissive projection screen; a position decoder for determining where on the front surface of the transmissive projection screen the dry pen is being pressed; and a projector for projecting an image on to the rear surface of the transmissive projection screen at the predetermined angle, the image representing writing corresponding to the positions the dry pen is pressed on the front surface.

17. A digital whiteboard system according to claim 16, wherein the dry pen comprises one or more infrared LEDs arranged to emit infrared signals when the dry pen is pressed against a surface; and the dry pen system comprises an infrared detector positioned to the rear side of the transmissive projection screen for detecting the infrared signals.

18. A digital whiteboard system according to claim 17, wherein the dry pen comprises plural infrared LEDs arranged in an annular ring around a nib of the dry pen.

19. A digital whiteboard system according to claim 17 wherein the dry pen comprises a colour selector switch and wherein the emitted infrared signals are modulated or coded according to a colour selected using the colour selector switch; and the dry pen system further comprises means for demodulating or decoding the infrared signals to determine which colour was selected and dependent thereon projecting the written image in the selected colour.

20. A digital whiteboard system according to claim 19, wherein the emitted infrared signals are modulated by driving the infrared LEDs at different frequencies.

21. A dry pen for a digital whiteboard system, comprising one or more infrared LEDs arranged to emit infrared signals when the dry pen is pressed against a surface.

22. A dry pen for a digital whiteboard system according to claim 21, wherein the dry pen comprises plural infrared LEDs arranged in an annular ring around a nib of the dry pen.

23. A dry pen for a digital whiteboard system according to claim 21, further comprising a colour selector switch and wherein the emitted infrared signals are modulated or coded according to a colour selected using the colour selector switch.

24. A dry pen for a digital whiteboard system according to claim 23, wherein the emitted infrared signals are modulated by driving the infrared LEDs at different frequencies.

25. (canceled)

26. (canceled)

27. (canceled)

28. (canceled)
